(19) United States
(12) Patent Application Publication
(10) Pub. No.: US 2026/0044949 A1
(43) Pub. Date: Feb. 12, 2026

(54) IMAGE GENERATION SYSTEM AND COMPUTER-READABLE RECORDING MEDIUM

(71) Applicant: FANUC CORPORATION, Yamanashi (JP)

(72) Inventors: Shinichi OZEKI, Yamanashi (JP); Nobuaki AIZAWA, Yamanashi (JP); Yuuki SUGITA, Yamanashi (JP)

(21) Appl. No.: 18/995,832

(22) PCT Filed: Sep. 20, 2022
(86) PCT No.: PCT/JP2022/035039

§ 371 Date: Jan. 17, 2025

(51) Int. Cl. G06T 7/00; G06T 11/00

(52) U.S. Cl. CPC G06T 7/001; G06T 11/00; G06T 2207/30164

(57) ABSTRACT

An image generation device includes: a merging unit merging first image data pertaining to a state of an industrial machine and data indicating an internal state of the industrial machine as image data; a first data storage storing the image data merged by the merging unit, in association with a date and time at which the first image data was acquired or a date and time at which the data indicating the internal state of the industrial machine was acquired; a second data storage storing second image data pertaining to a different state of the industrial machine than that of the first image data, in association with a date and time at which the second image data was acquired; and an output unit outputting, in response to an external request, the image data stored in the first data storage or the second image data stored in the second data storage.

### RELATED APPLICATIONS

The present application is a National Phase of International Application No. PCT/JP2022/035039 filed Sep. 20, 2022.

### TECHNICAL FIELD

The present invention relates to an image generation system and a computer-readable recording medium.

### BACKGROUND ART

At manufacturing sites where industrial machines are installed, operators may understand the operation state of an industrial machine by checking a screen of the industrial machine and the operation of the industrial machine, respectively. While an industrial machine is in operation, data collected from each part of the industrial machine, data detected by sensors attached to and around the industrial machine, or the like are stored in the industrial machine. This stored data is used by users who are located distant from the industrial machine or engineers who maintain the industrial machine to understand or analyze the operation state of the industrial machine.

For understanding of the operation state of an industrial machine, there are technologies to display an image that captures the industrial machine and an image of a screen displaying measured results of physical quantities related to the operation of the industrial machine in association with each other and thereby facilitate the understanding of information about manufacturing performed in the past (for example, Patent Literature 1 and others).

### CITATION LIST

### Patent Literature

Patent Literature 1: Japanese Patent Application Laid-Open No. 2018-073185

### SUMMARY OF INVENTION

### Technical Problem

Even though captured images are presented in combination, there are case where the operation state of an industrial machine cannot be accurately understood. Further, if the process to combine a plurality of images or data is configured to be performed on the client side, it is necessary to develop an additional necessary process.

### Solution to Problem

The image generation device according to the present invention solves the above problem by appropriately transmitting images that provide information necessary to understand the operation state of an industrial machine from the server side.

Further, one aspect of the present disclosure is an image generation system that generates an image used for understanding the state of an industrial machine, and the image generation system comprises: a first data storage unit that stores a first image data related to the state of the industrial machine in association with a time when the first image data was acquired; a second data storage unit that stores a second image data related to the state of the industrial machine different from the first image data in association with a time when the second image data was acquired; a subtitle data creation unit that creates subtitle related data indicating an internal state of the industrial machine based on data indicating the internal state of the industrial machine; a third data storage unit that stores the subtitle related data in association with a time when the internal state of the industrial machine was acquired; a search processing unit that searches the first data storage unit or the second data storage unit and searches the third data storage unit based on an acquisition request for the first image data or the second image data; an output unit that outputs data searched by the search processing unit; a display data acquisition unit that acquires data output by the output unit as screen display related data; a combining unit that combines screen display related data acquired by the display data acquisition unit into image data; and a screen display unit that displays the image data combined by the combining unit.

Another aspect of the present disclosure is a computer readable recording medium storing a program that causes a computer to operate as an image generation device that generates an image used for understanding the state of an industrial machine, and the program causes the computer to operate as: a first data storage unit that stores a first image data related to the state of the industrial machine in association with a time when the first image data was acquired; a second data storage unit that stores a second image data related to the state of the industrial machine different from the first image data in association with a time when the second image data was acquired; a subtitle data creation unit that creates subtitle related data indicating an internal state of the industrial machine based on data indicating the internal state of the industrial machine; a third data storage unit that stores the subtitle related data in association with a time when the internal state of the industrial machine was acquired; a search processing unit that searches the first data storage unit or the second data storage unit and searches the third data storage unit based on an acquisition request for the first image data or the second image data; and an output unit that outputs data searched by the search processing unit.

### Advantageous Effects of Invention

According to one aspect of the present disclosure, since data indicating the internal state of an industrial machine is combined with image data on the server side, it is not required to prepare dedicated functions on an operation environment for each client side, and the man-hours in the development can be expected to be reduced. Further, by the search processing unit that searches for the first image data, the second image data, and the third data stored at different times, it is possible to acquire each data at substantially the same time only by requesting data related to a single time on the data acquisition requesting side. Thus, the man-hour of development and the load of processing that are related to a requesting process performed on the client side can be expected to be reduced.

### BRIEF DESCRIPTION OF DRAWINGS

FIG. 1 is a schematic hardware configuration diagram of an image generation system according to one embodiment of the present invention.

FIG. 2 is a block diagram illustrating general functions of an image generation system according to a first embodiment of the present invention.

FIG. 3 is a diagram illustrating an example of image data on a display screen of an industrial machine according to the first embodiment.

FIG. 4 is a diagram illustrating an example of image data that captures the operation state of the industrial machine according to the first embodiment.

FIG. 5 is a diagram illustrating an example of image data combined by a combining unit according to the first embodiment.

FIG. 6 is a diagram illustrating another example of image data combined by the combining unit according to the first embodiment.

FIG. 7 is a diagram illustrating an example in which data output by an output unit is displayed on a terminal according to the first embodiment.

FIG. 8 is a diagram illustrating another example in which data output by the output unit is displayed on the terminal according to the first embodiment.

FIG. 9 is a block diagram illustrating general functions of an image generation system according to a second embodiment of the present invention.

FIG. 10 is a block diagram illustrating general functions of an image generation system according to another embodiment of the present invention.

FIG. 11 is a diagram illustrating an example of image data combined by a combining unit according to another embodiment.

### DESCRIPTION OF EMBODIMENTS

Embodiments of the present invention will be described below with reference to the drawings.

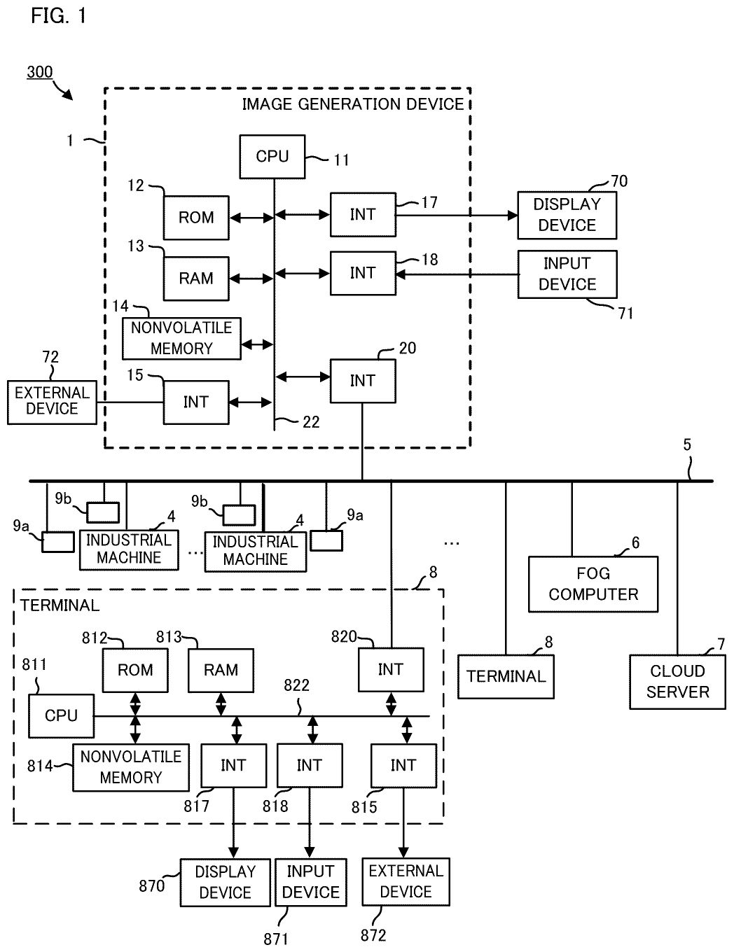

FIG. 1 is a schematic hardware configuration diagram illustrating the main part of an image generation system according to one embodiment of the present invention. An image generation system 300 according to the present embodiment is configured when an image generation device 1 and terminals 8 are connected to each other via a network 5. The image generation device 1 can be implemented on a control device that controls industrial machines 4 installed in a manufacturing site such as a factory. Further, the image generation device 1 can be implemented on a personal computer provided together with a control device or a computer such as a fog computer 6, a cloud server 7, or the like connected to the control device via a wired or wireless network. In the following, the image generation device 1 according to the present embodiment will be described based on an example in which the image generation device 1 is connected via a network to a control device that controls the industrial machines 4 and implemented on a personal computer that operates as a server.

A CPU 11 included in the image generation device 1 according to the present embodiment is a processor that generally controls the image generation device 1. The CPU 11 reads a system program stored in a ROM 12 via a bus 22 and controls the entire image generation device 1 in accordance with the system program. A RAM 13 temporarily stores temporary calculation data or display data and externally input various data or the like.

A nonvolatile memory 14 is formed of a memory backed up by a battery (not illustrated), a solid state drive (SSD), or the like, for example, and the storage state thereof is maintained even when the image generation device 1 is powered off. The nonvolatile memory 14 stores data acquired from the industrial machines 4, image data acquired from image capturing sensors 9a, 9b, a program or data loaded from an external device 72 via an interface 15, a program or data input via an input device 71, a program or data acquired from other devices via the network 5, or the like. The program or data stored in the nonvolatile memory 14 may be loaded into the RAM 13 during execution or during use. Further, in the ROM 12, various system programs such as known analysis programs are written in advance.

The interface 15 is an interface used for connecting the CPU 11 of the image generation device 1 and the external device 72 such as a USB device to each other. For example, a program, setup data, or the like are loaded from the external device 72 side. Further, a program, setup data, or the like edited within the image generation device 1 can be stored in an external storage device via the external device 72.

An interface 20 is an interface used for connecting the CPU 11 of the image generation device 1 and the wired or wireless network 5 to each other. The industrial machines 4, the fog computer 6, the cloud server 7, and the like are connected to the network 5 and transfer data to and from the image generation device 1.

Respective data loaded into a memory, data obtained as a result of execution of a program or the like, and so on are output via an interface 17 to and displayed on the display device 70. The display device 70 may have an LED indicator or an alert lamp indicating the state of the machine. Further, the input device 71 formed of a keyboard, a pointing device, or the like passes instructions, data, or the like, which are based on an operation made by an operator, to the CPU 11 via the interface 18.

The image generation device 1 forms the image generation system 300 together with at least one industrial machine 4 and at least one terminal 8 connected to the image generation device 1 via the network 5.

Each industrial machine 4 is a machine tool, an electric discharge machine, a robot, or the like installed in a manufacturing site such as a factory. The image capturing sensors 9a, 9b are installed near the industrial machine 4. The image capturing sensor 9a is installed so as to be able to capture an image of a view of machining being performed on a workpiece by the industrial machine 4, the operation of the industrial machine 4 itself, the surrounding condition, or the like. The image capturing sensor 9a may be, for example, a camera or the like. The image capturing sensor 9b is installed so as to be able to capture an image of a display screen of a control device that controls the industrial machine 4. The image capturing sensor 9b may be, for example, a camera, a capture device, or the like. The image capturing sensors 9a, 9b generate image data such as static images or moving images. Image data generated by the image capturing sensors 9a, 9b are passed to the CPU 11 via the network 5 and the interface 20.

Each terminal 8 operates as a client of the image generation device 1. The terminal 8 may be a personal computer installed distant from the industrial machine 4 or the image generation device 1, for example. Further, the terminal 8 may be a portable device carried by the operator or the like. The terminal 8 has at least a function of acquiring and displaying image data generated by the image generation device 1 via the network 5.

A CPU 811 provided in the terminal 8 is a processor that controls the entire terminal 8. The CPU 811 reads a system program stored in a ROM 812 via a bus 822 and controls the entire terminal 8 in accordance with the system program. A RAM 813 temporarily stores temporary calculation data or display data and externally input various data or the like.

A nonvolatile memory 814 is formed of a memory backed up by a battery (not illustrated), a solid state drive (SSD), or the like, for example, and the storage state thereof is maintained even when the terminal 8 is powered off. The nonvolatile memory 814 stores a program or data acquired from the image generation device 1 or other devices via the network 5, a program or data input via an input device 871, or the like. The program or data stored in the nonvolatile memory 814 may be loaded into the RAM 813 during execution or during use. Further, in the ROM 812, various system programs such as known image processing programs are written in advance.

The interface 815 is an interface used for connecting the CPU 811 of the terminal 8 and the external device 872 such as a USB device to each other. For example, a program, data, or the like are loaded from the external device 872 side. Further, a program, data, or the like created within the terminal 8 can be stored in an external storage device via the external device 872.

An interface 820 is an interface used for connecting the CPU 811 of the terminal 8 and the wired or wireless network 5 to each other. The image generation device 1, the industrial machines 4, the fog computer 6, the cloud server 7, and the like are connected to the network 5 and transfer data to and from the terminal 8.

Respective data loaded into a memory, data obtained as a result of execution of a program or the like, and so on are output via an interface 817 to and displayed on the display device 870. Further, the input device 871 formed of a keyboard, a pointing device, a touch panel, or the like passes instructions, data, or the like, which are based on an operation made by an operator, to the CPU 811 via the interface 818.

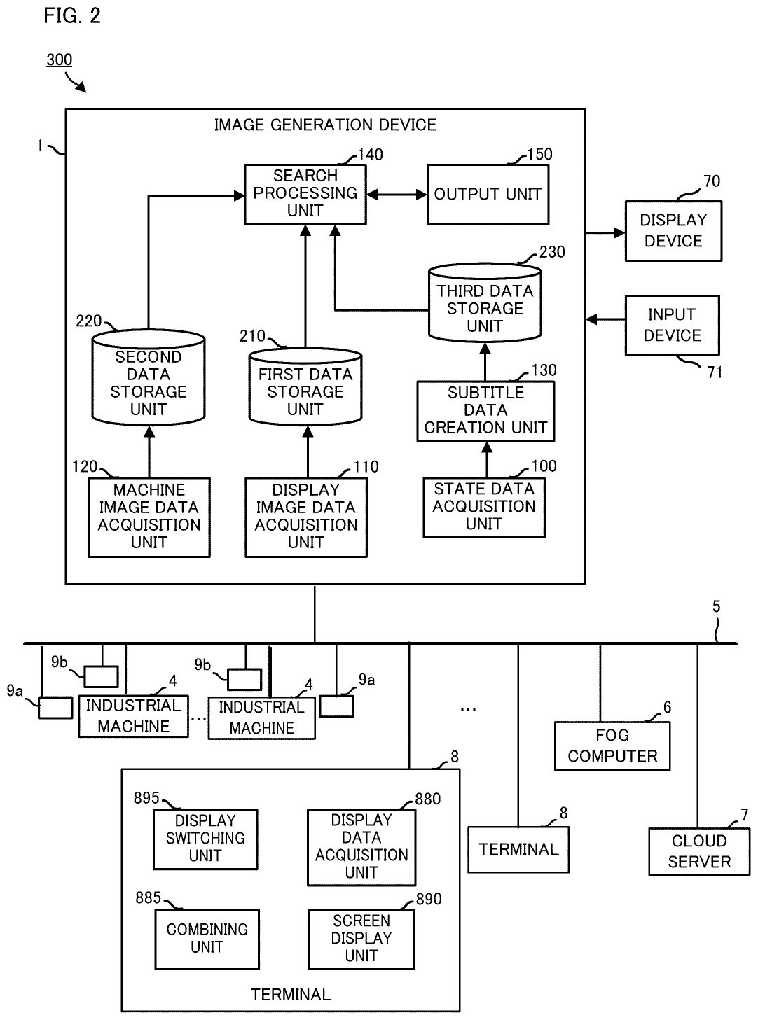

FIG. 2 illustrates functions of the image generation device 1 and the terminal 8 according to the first embodiment of the present invention in a schematic block diagram. Each function of the image generation device 1 and the terminal 8 according to the present embodiment is implemented when the CPU 11 of the image generation device 1 and the CPU 811 of the terminal 8 illustrated in FIG. 1 execute the system programs, respectively, and control the operation of each unit of the image generation device 1 and the terminal 8.

The image generation device 1 according to the present embodiment includes a state data acquisition unit 100, a display image data acquisition unit 110, a machine image data acquisition unit 120, a subtitle data creation unit 130, a search processing unit 140, and an output unit 150. Further, on the RAM 13 or the nonvolatile memory 14 of the image generation device 1, a first data storage unit 210 that is an area for storing image data that captures a display screen of a control device that controls the industrial machine 4, a second data storage unit 220 that is an area for storing image data that captures the operation state of the industrial machine 4, and a third data storage unit 230 that is an area for storing subtitle related data indicating the internal state of the industrial machine 4 are prepared in advance.

The state data acquisition unit 100 acquires, from the industrial machine 4, data indicating the internal state of the industrial machine 4. The state data acquisition unit 100 acquires, from the control device of the industrial machine 4, data indicating the internal state of the industrial machine 4. The data indicating the internal state of the industrial machine 4 may be, for example, a value of an operation signal from an operator of the industrial machine 4, a value of an operating signal, a value of a macro variable, a name of a tool in use, a dimensional value of a tool in use, a workpiece coordinate value, a setup value of a predetermined parameter, an instruction of a machining program during execution, or the like. The data indicating the internal state of the industrial machine 4 may be time-series data that is a series of values acquired at a predetermined cycle. The data indicating the internal state of the industrial machine 4 is associated with at least the time when the data was acquired or a time since the industrial machine 4 started operating. The state data acquisition unit 100 outputs the acquired data indicating the internal state of the industrial machine 4 to the subtitle data creation unit 130.

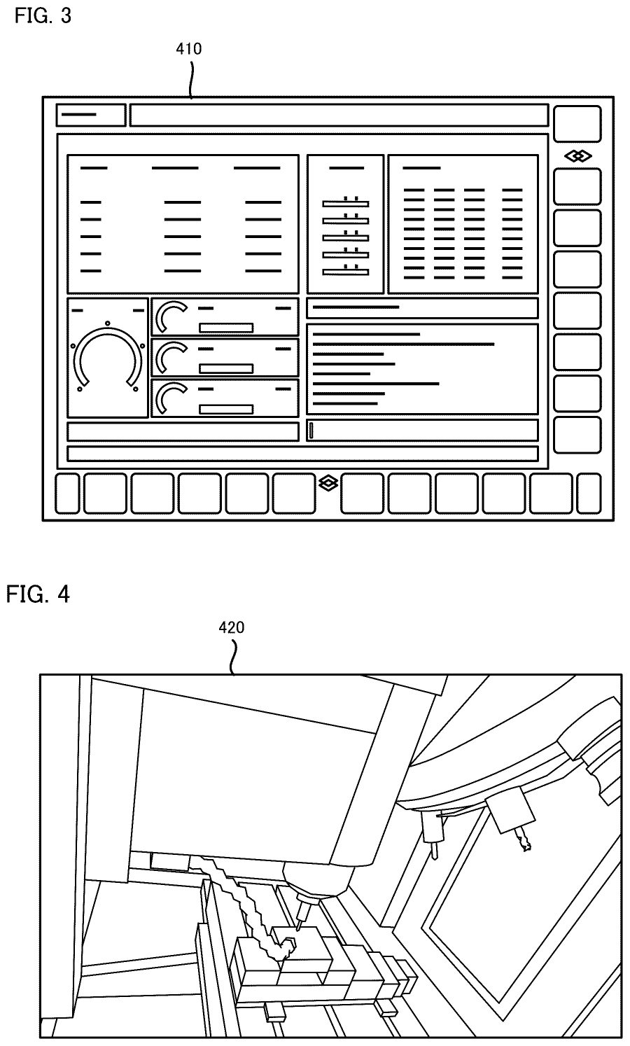

The display image data acquisition unit 110 acquires image data that captures a display screen of the control device that controls the industrial machine 4. The display image data acquisition unit 110 acquires image data of a display screen from the image capturing sensor 9b. FIG. 3 illustrates an example of image data 410 of a display image acquired by the display image data acquisition unit 110. The image data 410 of a display image may be time-series data of static images acquired at a predetermined cycle. Further, the image data 410 of a display image may be data of a moving image. The image data 410 of a display screen is associated with at least the time when the data was acquired or a time since the industrial machine 4 started operating. The display image data acquisition unit 110 stores the acquired image data 410 of the display screen in the first data storage unit 210.

The machine image data acquisition unit 120 acquires image data that captures the operation state of the industrial machine 4, such as a view of machining on a workpiece, the operation of the industrial machine 4 itself, the surrounding conditions, or the like. The machine image data acquisition unit 120 acquires, from the image capturing sensor 9a, image data that captures the operation state of the industrial machine 4. FIG. 4 illustrates an example of image data 420 that captures the operation state of the industrial machine 4 acquired by the machine image data acquisition unit 120. The image data 420 that captures the operation state of the industrial machine 4 may be time-series data of static images acquired at a predetermined cycle. Further, the image data 420 of a display image may be data of a moving image. The image data 420 that captures the operation state of the industrial machine 4 is associated with at least the time when the data was acquired or a time since the industrial machine 4 started operating. The machine image data acquisition unit 120 stores the acquired image data 420 that captures the operation state of the industrial machine 4 in the second data storage unit 220.

The subtitle data creation unit 130 creates subtitle related data indicating the internal state of the industrial machine 4 based on data indicating the internal state of the industrial machine 4 input from the state data acquisition unit 100. The subtitle related data may be, for example, a character string representing the internal state of the industrial machine 4. Further, the subtitle related data may be an imaged character string indicating the internal state of the industrial machine 4. The subtitle related data created by the subtitle data creation unit 130 may be one representing a character string that means a predetermined state indicated by data indicating the internal state of the industrial machine 4. For example, when the automatic operation signal is ON in the industrial machine 4, subtitle related data such as “Automatic Operation” may be created. Further, when the value of override is set to 100% in the industrial machine 4, subtitle related data such as “Rapid Traverse Override 100%” may be created. The subtitle related data may be one indicating a character string written in a predetermined single language or may be one indicating character strings written in a plurality of languages. The subtitle data creation unit 130 associates period data, which indicates the time when the industrial machine 4 entered a predetermined state and a predefined predetermined period, with the created subtitle related data and stores the associated data in the third data storage unit 230.

The search processing unit 140 searches for the first data storage unit 210, the second data storage unit 220, and the third data storage unit 230 for image data requested by an acquisition request when the output unit 150 receives the acquisition request for image data from the terminal 8. The search processing unit 140 then outputs the obtained data as a result of the search to the output unit 150. The acquisition request from the terminal 8 includes at least a request for the type of image data. The request for the type of image data is either a request for image data of a display image or a request for image data that captures the operation state of the industrial machine 4. When a request for image data of a display image is included in the acquisition request, the search processing unit 140 searches for the requested image data for a display image out of the data stored in the first data storage unit 210. Further, when a request for image data that captures the operation state of the industrial machine 4 is included in the acquisition request, the search processing unit 140 searches for the requested image data for a display image out of the data stored in the second data storage unit 220. The search processing unit 140 then outputs the obtained image data to the output unit 150. In any case, the search processing unit 140 may search for subtitle related data stored in the third data storage unit 230 in accordance with the searched image data and outputs the searched data to the output unit 150.

The acquisition request from the terminal 8 may include information uniquely identifying the industrial machine 4. When the identification information on the industrial machine 4 is included, the search processing unit 140 searches for image data related to the industrial machine 4 corresponding to the requested identification information out of the image data stored in respective storage units.

The acquisition request from the terminal 8 may include a request related to time. When a request related to time is included, the search processing unit 140 searches for image data captured at the time closest to the requested time out of the image data stored in respective storage units. The search processing unit 140 may search for image data captured at the time closest to and on or before the requested time. The search processing unit 140 then outputs the obtained image data to the output unit 150. In any case, the search processing unit 140 may search the third data storage unit 230 for the subtitle related data at the time close to the time of capturing of the searched image data in accordance with the searched image data and output the searched data to the output unit 150.

The output unit 150 instructs the search processing unit 140 to perform searching for image data based on a request from the terminal 8. The output unit 150 then outputs the image data and the subtitle related data searched by the search processing unit 140 via the network 5. In response to the request from a single terminal 8, the output unit 150 may exclusively output any of the data stored in the first data storage unit 210 or the second data storage unit 220 at the same timing. The output unit 150 may modify the output data in accordance with the type of the terminal 8. For example, templates defining the arrangement or the size of image data for each type of the terminal 8 are prepared in advance. The output unit 150 may then determine the type of the terminal 8 included in the request from the terminal 8, modify data based on a template corresponding to the determined type of the terminal 8, and then output the modified data to the terminal 8. The data output by the output unit 150 is displayed on the terminal 8. This display may be displayed as a static image or may be displayed as a moving image.

The terminal 8 according to the present embodiment includes a display data acquisition unit 880, a combining unit 885, a screen display unit 890, and a display switching unit 895.

The display data acquisition unit 880 requests the image generation device 1 to acquire screen display related data. The display data acquisition unit 880 then acquires screen display related data transmitted from the image generation device 1 via the network 5 as a response to the acquisition request. The acquisition request transmitted to the image generation device 1 by the display data acquisition unit 880 includes at least a request for the type of image data. The request for the type of image data is a request for the image data of a display image or a request for image data that captures the operation state of the industrial machine 4. For example, when a request for image data of a display image is included in the acquisition request, the display data acquisition unit 880 can acquire the requested image data of a display image and subtitle related data. Further, when a request for image data that captures the operation state of the industrial machine 4 is included in the acquisition request, the display data acquisition unit 880 can acquire the requested image data that captures the operation state of the industrial machine 4 and subtitle related data. The display data acquisition unit 880 may include information uniquely identifying the industrial machine 4 in the request to the image generation device 1. Further, the display data acquisition unit 880 may include a request for time in the request to the image generation device 1. The display data acquisition unit 880 outputs the acquired screen display related data to the combining unit 885.

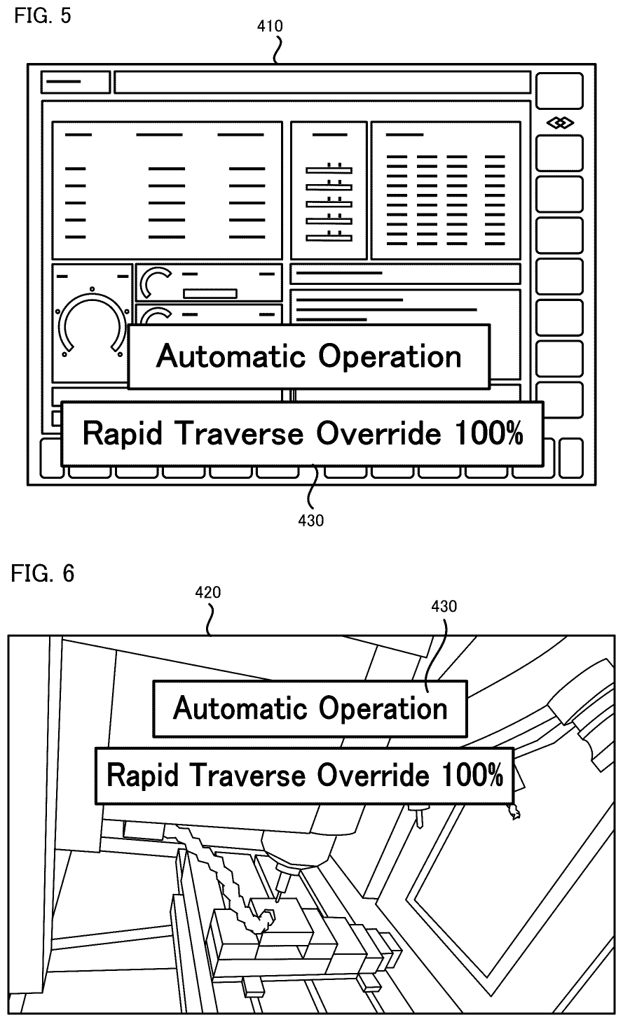

The combining unit 885 combines screen display related data acquired by the display data acquisition unit 880 into image data. FIG. 5 illustrates an example of image data combined by the combining unit 885. As illustrated in FIG. 5 as an example, the combining unit 885 creates image data 430 related to a subtitle based on data indicating the internal state of the industrial machine 4, for example. The combining unit 885 may then combine the image data 410 of a display screen and data indicating the internal state of the industrial machine 4 by superimposing the created image data 430 related to the subtitle on the image data 410 of the display screen. The background of the image data 430 related to a subtitle may be a translucent image through which the image data 410 of the display screen is viewed. In addition, the combining unit 885 may create, for example, image data related to a graph indicating a change of data indicating the internal state of the industrial machine 4 or image data indicating a predefined predetermined internal state (for example, an alert mark or the like) and combine the created image data with the image data 410 of a display screen. The combining unit 885 may combine data in which times associated with respective data are the same or close to each other. FIG. 6 illustrates another example of image data combined by the combining unit 885. As illustrated in FIG. 6 as an example, the combining unit 885 may combine the image data 420 that captures the operation state of the industrial machine 4 and the data indicating the internal state of the industrial machine 4 by superimposing the image data 430 related to a subtitle on the image data 420 that captures the operation state of the industrial machine 4. The combining unit 885 outputs the combined screen display related data to the screen display unit 890.

The screen display unit 890 displays screen display related data combined by the combining unit 885 on the display device 870.

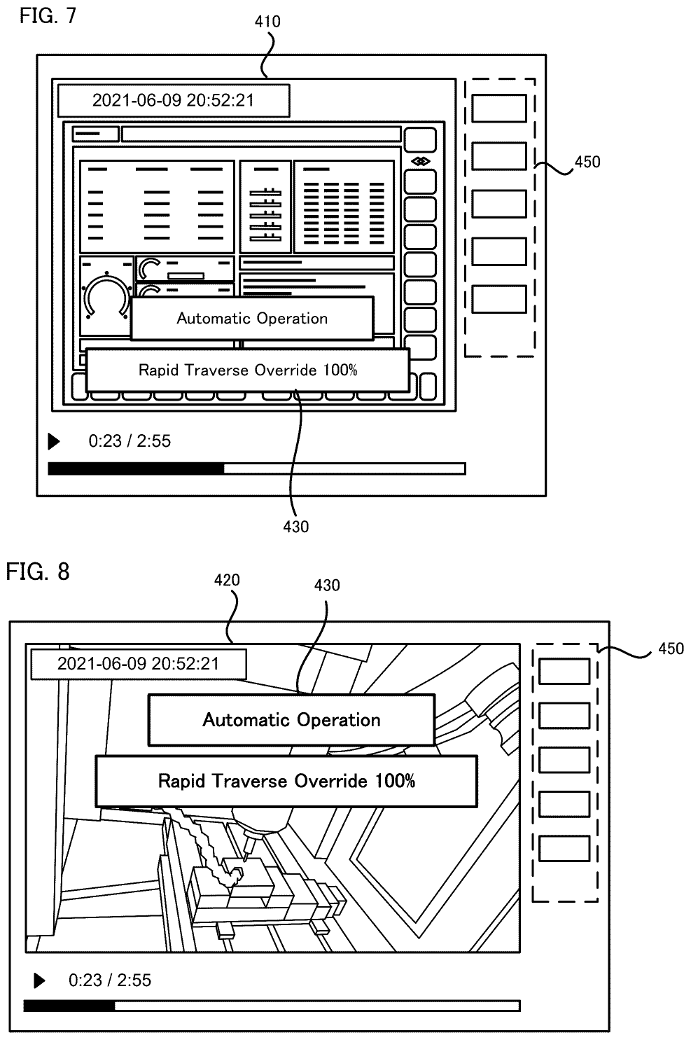

FIG. 7 illustrates an example of a screen displayed on the terminal 8. FIG. 7 illustrates an example of display when image data of a display image and subtitle related data are combined into the screen display related data. In the example of FIG. 7, the image data 410 related to a display screen is a moving image, and the associated time is superimposed on and displayed at the left upper of the image data. The image data of a display image and the image data 430 related to a subtitle are updated as the display time elapses. As illustrated in FIG. 7 as an example, it is possible to view the internal state of the industrial machine 4 in the subtitle while viewing the display screen of the control device on the terminal 8. The display screen displayed on the display device 870 by the screen display unit 890 may include an operation panel 450 as illustrated in FIG. 7 as an example. The operation panel 450 includes at least one operatable object and accepts a user operation.

The display switching unit 895 switches screen display related data acquired by the display data acquisition unit 880 based on a user operation. For example, the display switching unit 895 may switch screen display related data acquired by the display data acquisition unit 880 based on the user operation performed on the input device 871. For example, this user operation may be an operation performed on a keyboard, a pointing device, a touch panel, or the like. For example, the operatable object included in the operation panel 450 illustrated in FIG. 7 as an example may include an operation button used for switching the image data 410 related to a display screen to the image data 420 that captures the operation state of the industrial machine 4. In such a case, in response to the user operating the operation button, the display switching unit 895 instructs the display data acquisition unit 880 to switch the screen display related data intended to acquire to the image data that captures the operation state of the industrial machine 4 based on the user operation. The screen display unit 890 then displays a screen in which the image data 430 related to a subtitle is superimposed on the image data 420 that captures the operation state of the industrial machine 4 as illustrated in FIG. 8 as an example based on the image data that captures the operation state of the industrial machine 4 and the subtitle related data acquired by the display data acquisition unit 880. The operation panel 450 illustrated in FIG. 8 as an example may include an operation button used for switching the display to the image data 410 of the display image.

As described above, when switching the display between the image data 410 of a display image and the image data 420 that captures the operation state of the industrial machine 4, the display switching unit 895 may instruct the display data acquisition unit 880 to include a request for the currently displayed time in the acquisition request to the image generation device 1. With such a configuration, while viewing a predetermined image at a certain time, the user is able to view another image captured at the same time via a display switching operation. Further, the display switching unit 895 may instruct the display data acquisition unit 880 to include a request for the time that is a predefined predetermined time before the currently displayed time (for example, 5 seconds before) in the acquisition request to the image generation device 1. With such a configuration, while viewing a predetermined image at a certain time, the user is able to view the image from another image captured at a time slightly before the certain time via a display switching operation.

The display switching unit 895 may accept an operation of switching the industrial machine 4 intended to display. The display switching unit 895 instructs the display data acquisition unit 880 to include information uniquely identifying the industrial machine 4 designated by the user operation in the acquisition request to the image generation device 1.

Since the image generation device 1 including the above configuration can suitably switch one image data on display to another image data acquired at substantially the same time and view these image data by operating the client side, it is possible to understand a temporal correlation with another image data if necessary while referencing the details of the image data.

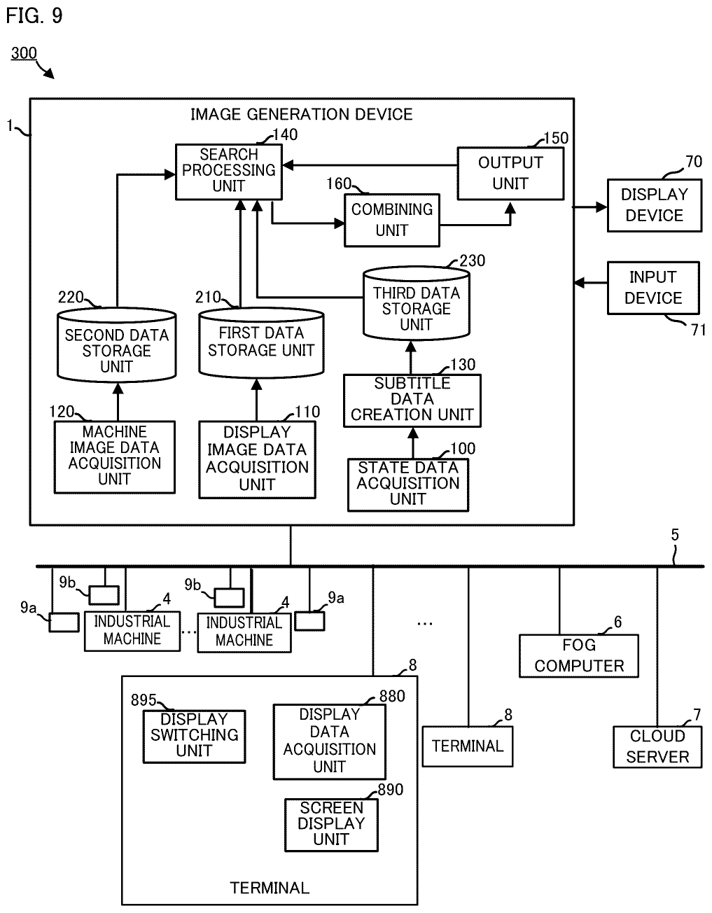

FIG. 9 illustrates functions of the image generation device 1 and the terminal 8 according to the second embodiment of the present invention as a schematic block diagram. Each function of the image generation device 1 and the terminal 8 according to the present embodiment is implemented when the CPU 11 of the image generation device 1 and the CPU 811 of the terminal 8 illustrated in FIG. 1 execute the system programs, respectively, and control the operation of each unit of the image generation device 1 and the terminal 8.

The image generation device 1 and the terminal 8 according to the present embodiment differ from the image generation device 1 and the terminal 8 according to the first embodiment in that the image generation device 1 includes the function of the combining unit 885 of the terminal 8 according to the first embodiment.

The image generation device 1 according to the present embodiment includes a combining unit 160. The combining unit 160 combines image data searched by the search processing unit 140 with subtitle related data into one image data. The combining unit 160 has the same function as the combining unit 885 of the terminal 8 according to the first embodiment. The combining unit 160 outputs the combined image data to the output unit 150.

The output unit 150 according to the present embodiment then transmits and outputs the input image data to the terminal 8.

Since the image generation device 1 including the above configuration combines data indicating the internal state of the industrial machine 4 with image data on the side of the image generation device 1 that is a server, there is no need to prepare a dedicated function for each operation environment of clients, and the man-hour in development can be expected to be reduced. Further, during viewing of image data, the load related to the operation of the terminal 8 as a client is reduced.

Although the embodiments of the present invention have been described above, the present invention is not limited to only the examples in the embodiments described above and can be implemented in various forms with addition of a suitable change.

For example, in the embodiments described above, image data obtained by capturing the industrial machine 4 by using the image capturing sensor 9a is used as the image data that captures the operation state of the industrial machine 4. However, this image data may be replaced with image data created through a known machining simulation technology. Depending on the type of the industrial machine 4, there may be a case where an image of the state of a workpiece being machined is not captured well due to a cutting liquid and so on. In such a case, the use of an image created through a machining simulation technology instead of image data captured by the image capturing sensor 9a enables easier understand of the operation state of the industrial machine 4.

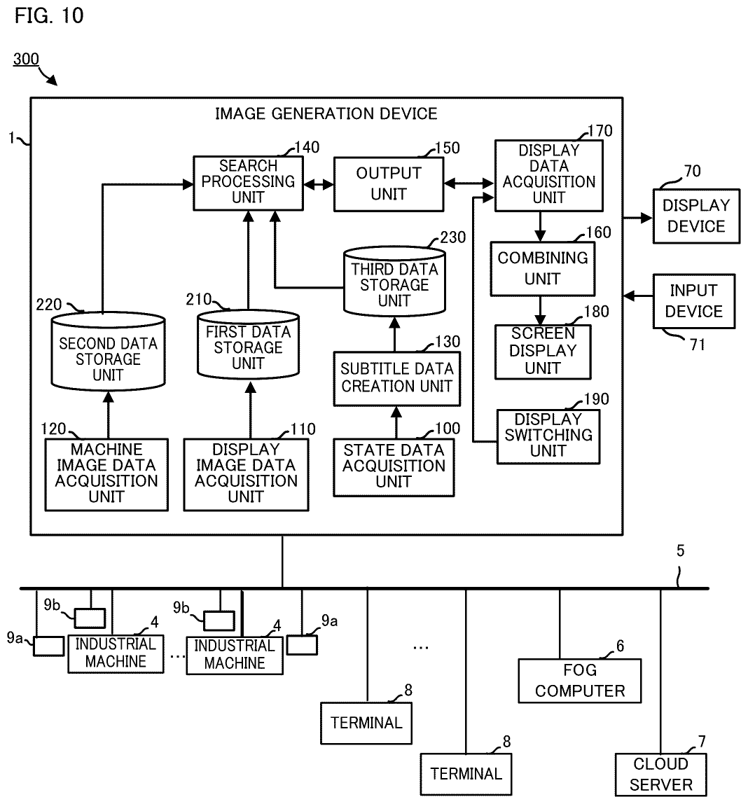

Further, the examples in which the image generation device 1 and the terminal 8 are implemented on different computers have been illustrated in the above embodiments. As illustrated in FIG. 10 as an example, however, respective functions may be implemented on a single computer. In FIG. 10, the display data acquisition unit 170, the combining unit 160, the screen display unit 180, and the display switching unit 190 have the same functions as the display data acquisition unit 880, the combining unit 885, the screen display unit 890, and the display switching unit 895 according to the first embodiment, respectively. With such a configuration, the system for the user to observe the state of the industrial machine 4 by using only the image generation device 1 can be constructed at less cost.

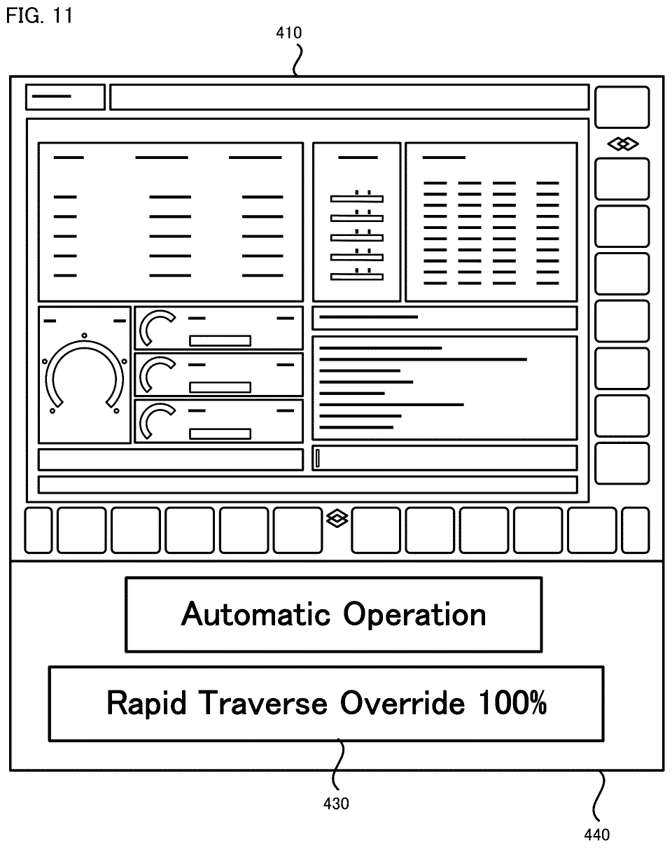

Furthermore, in the embodiments described above, the combining unit creates image data in which a subtitle indicating the internal state of the industrial machine 4 are superimposed on the image data 410 of a display screen or the image data 420 that captures the operation state of the industrial machine 4. However, for example, as illustrated in FIG. 11, a region 440 having a predetermined size may be provided to outside of the image data, and image data in which a subtitle indicating the internal state of the industrial machine 4 is superimposed on the region 440 may be created. The region 440 may be provided at any position of above, below, left to, or right to image data. With such a configuration, since the subtitle does not hide image data, browsability of information is expected to improve.

1. An image generation system that generates an image used for understanding the state of an industrial machine, the image generation system comprising:
a first data storage unit that stores a first image data related to the state of the industrial machine in association with a time when the first image data was acquired;
a second data storage unit that stores a second image data related to the state of the industrial machine different from the first image data in association with a time when the second image data was acquired;
a subtitle data creation unit that creates subtitle related data indicating an internal state of the industrial machine based on data indicating the internal state of the industrial machine;
a third data storage unit that stores the subtitle related data in association with a time when the internal state of the industrial machine was acquired;
a search processing unit that searches for the first data storage unit or the second data storage unit and searches for the third data storage unit based on an acquisition request for the first image data or the second image data;
an output unit that outputs data searched by the search processing unit;
a display data acquisition unit that acquires data output by the output unit as screen display related data;
a combining unit that combines screen display related data acquired by the display data acquisition unit into image data; and
a screen display unit that displays the image data combined by the combining unit.

2. The image generation system according to claim 1,
wherein the first image data is image data indicating a display image of the industrial machine, and
wherein the second image data is image data that captures the operation state of the industrial machine.

3. The image generation system according to claim 1,
wherein the first image data is image data that captures the operation state of the industrial machine, and
wherein the second image data is image data indicating a display image of the industrial machine.

4. The image generation system according to claim
wherein the data indicating the internal state of the industrial machine includes information on at least any one of a value of an operation signal from an operator of the industrial machine, a value of an operating signal, a value of a macro variable, a name of a tool in use, a dimensional value of a tool in use, a workpiece coordinate value, a setup value of a predetermined parameter, and an instruction of a machining program being executed.

5-8. (canceled)

9. The image generation system according to claim 3,
wherein the data indicating the internal state of the industrial machine includes information on at least any one of a value of an operation signal from an operator of the industrial machine, a value of an operating signal, a value of a macro variable, a name of a tool in use, a dimensional value of a tool in use, a workpiece coordinate value, a setup value of a predetermined parameter, and an instruction of a machining program being executed.

10. The image generation system according to claim 2,
wherein the combining unit combines the data indicating the internal state of the industrial machine in at least any one of forms of image information and subtitle information.

11. The image generation system according to claim 3,
wherein the combining unit combines the data indicating the internal state of the industrial machine in at least any one of forms of image information and subtitle information.

12. The image generation system according to claim 1,
wherein the acquisition request is any one of a request for the first image data and a request for the second image data,
wherein the search processing unit
searches the first data storage unit for the first image data and searches the third data storage unit for subtitle related data associated with the searched first image data when the acquisition request is the request for the first image data, and
searches the second data storage unit for the second image data and searches the third data storage unit for subtitle related data associated with the searched second image data when the acquisition request is the request for the second image data.

13. The image generation system according to claim 12,
wherein the acquisition request further includes a request for a time, and
wherein the search processing unit searches for data acquired at a time close to the requested time.

14. A computer readable recording medium storing a program that causes a computer to operate as an image generation device that generates an image used for understanding the state of an industrial machine, the program causing the computer to operate as:
a first data storage unit that stores a first image data related to the state of the industrial machine in association with a time when the first image data was acquired;
a second data storage unit that stores a second image data related to the state of the industrial machine different from the first image data in association with a time when the second image data was acquired;
a subtitle data creation unit that creates subtitle related data indicating an internal state of the industrial machine based on data indicating the internal state of the industrial machine;
a third data storage unit that stores the subtitle related data in association with a time when the internal state of the industrial machine was acquired;
a search processing unit that searches for the first data storage unit or the second data storage unit and searches for the third data storage unit based on an acquisition request for the first image data or the second image data; and
an output unit that outputs data searched by the search processing unit.
